(19) United States
(12) Patent Application Publication
(10) Pub. No.: US 2020/0116498 A1
(43) Pub. Date: Apr. 16, 2020

(54) VISUAL ASSISTED DISTANCE-BASED SLAM METHOD AND MOBILE ROBOT USING THE SAME

(71) Applicant: UBTECH Robotics Corp, Shenzhen (CN)

(72) Inventors: Youjun Xiong, Shenzhen (CN); Chenchen Jiang, Shenzhen (CN); Longbiao Bai, Shenzhen (CN); Zhanjia Bi, Shenzhen (CN); Zhichao Liu, Shenzhen (CN)

(21) Appl. No.: 16/228,792

(22) Filed: Dec. 21, 2018

(30) Foreign Application Priority Data
Oct. 16, 2018 (CN) 201811203021.8

(51) Int. Cl. G01C 21/32; G06T 7/73; G05D 1/02

(52) U.S. Cl. CPC G01C 21/32; G06T 7/74; G05D 1/0246; G05D 2201/02; G05D 1/0274; G06T 2207/30244; G05D 1/024

(57) ABSTRACT

The present disclosure provides a visual assisted distance-based SLAM method for a mobile robot, and a mobile robot using the same. The method includes: obtaining distance data frames and visual data frames, each of the visual data frames corresponds to one of the distance data frames, performing a loop closure detection based on a current visual data frame in the visual data frames to find a matched visual data frame; calculating a relative pose between the current visual data frame and the matched visual data frame; and performing a loop closure optimization on pose data of one or more frames between the current visual data frame and the matched visual data frame based on the relative pose. In the above-mentioned manner, the present disclosure can improve the accuracy of mapping and/or realizing fast relocalization.

### CROSS REFERENCE TO RELATED APPLICATIONS

This application claims priority to Chinese Patent Application No. 201811203021.8, filed Oct. 16, 2018, which is hereby incorporated by reference herein as if set forth in its entirety.

### BACKGROUND

### 1. Technical Field

The present disclosure relates to robot technology, and particularly to a visual assisted distance-based SLAM (simultaneous localization and mapping) method for a mobile robot and a mobile robot using the same.

### 2. Description of Related Art

Simultaneous localization and mapping (SLAM) refers to a technology that generates localization and scene map information of a carrier's own position and posture (called “pose” for short) by collecting and calculating various sensor data on the carrier (e.g., a mobile robot or an unmanned aerial vehicle).

There are two common types of SLAM: distance-based SLAM and vision-based SLAM. Distance-based SLAM (distance SLAM) such as lidar-based SLAM (laser SLAM) uses distance sensor to measure the distance with respect to objects around the carrier, and the obtained object information presents a series of scattered points having accurate angle and distance information which are called a point cloud. By matching and comparing two point clouds at different times, the distance of the relative motion and the change of the posture (i.e., relative pose) of the distance sensor are calculated, thereby completing the localization of the carrier itself.

The pose of the nth frame in SLAM is calculated based on the pose of the n−1th frame and a relative pose between the two frames. If there is an error in the pose of the n−1th frame, the error will be transferred to the nth frame and all of its subsequent frames, thereby resulting in a cumulative error. To this end, loop closure detection can be used to determine whether the two frames are collected in the same scene by determining whether the similarity of the data of different frames meets the requirements. If it is detected that the ith frame and the jth frame are collected in the same scene, the pose of the ith to jth frames can be optimized.

For the distance SLAM, since the amount of information included in a point cloud is small, the similarity of the point cloud of different frames cannot accurately reflect the similarity of the corresponding scene. Especially for the empty scenes, the loop detection is difficult to be performed, and it is difficult to eliminate the cumulative error, which affects the reliability of long-term estimates. Similarly, since the amount of information included in the point cloud is small, in the case that the tracking is lost during the booting/localization process of the carrier, it is difficult to find a matching part in the entire map according to the current point cloud data, and it is difficult to perform the overall relocalization.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a schematic block diagram of the structure of a mobile robot according to an embodiment of the present disclosure.

FIG. 2 is a flow chart of a first embodiment of a visual assisted distance-based SLAM method according to the present disclosure.

FIG. 3 is a flow chart of a second embodiment of a visual assisted distance-based SLAM method according to the present disclosure.

FIG. 4 is a flow chart of a third embodiment of a visual assisted distance-based SLAM method according to the present disclosure.

FIG. 5 is a schematic block diagram of an overall scheme of a laser SLAM according to an embodiment of the visual assisted distance-based SLAM method of the present disclosure.

FIG. 6 is a flow chart of a fourth embodiment of a visual assisted distance-based SLAM method according to the present disclosure.

### DETAILED DESCRIPTION

The present disclosure will be described in detail in conjunction with the drawings and embodiments. The non-conflicting parts in the following embodiments may be combined with each other. In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

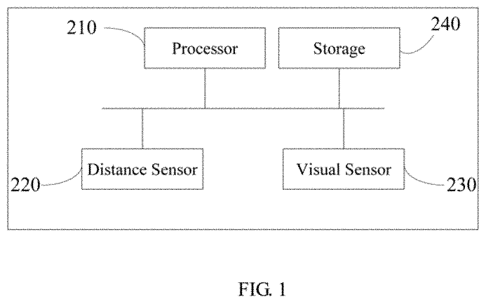

FIG. 1 is a schematic block diagram of the structure of a mobile robot according to an embodiment of the present disclosure. As shown in FIG. 1, a mobile robot includes a processor 210, a distance sensor 220, a visual sensor 230, and a storage 240. The processor 210 is coupled to each of the distance sensor 220 and the visual sensor 230.

The processor 210 controls the operation of the mobile robot, which may also be referred to as a CPU (Central Processing Unit). The processor 210 may be an integrated circuit chip which is capable of processing a signal sequence. The processor 210 can also be a general purpose processor, a digital signal sequence processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

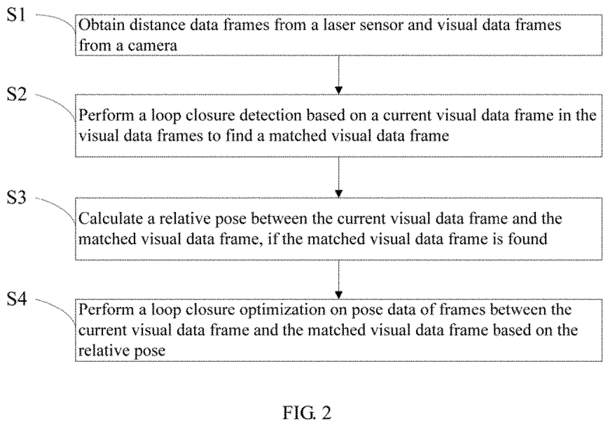

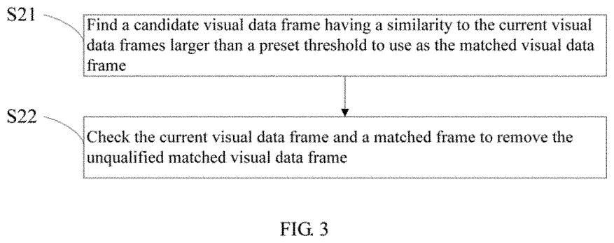

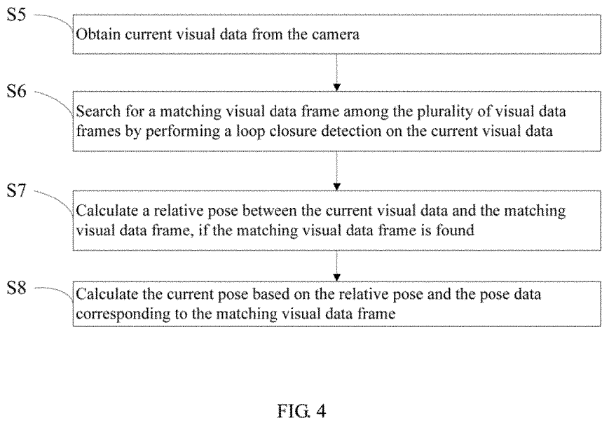

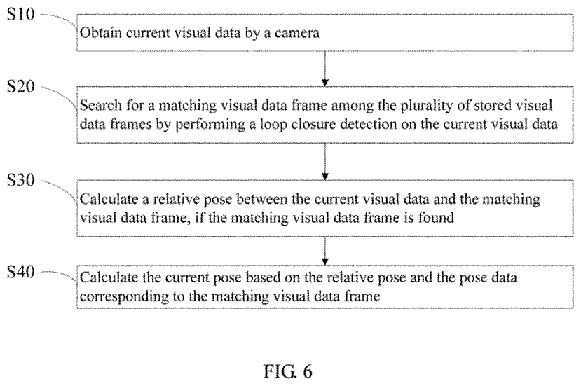

The processor 210 is configured to execute instructions to implement any of the embodiments of the visual assisted distance-based SLAM method of the present disclosure (as shown in FIG. 2, FIG. 3, FIG. 4, and FIG. 6) and the methods provided by the non-conflicting combination.

The storage 240 (e.g., a memory) is configured to store computer program(s) which include instructions executable on the processor 210. In this embodiment, the computer program(s) include:

instructions for obtaining a plurality of distance data frames and a plurality of visual data frames, wherein each of the plurality of visual data frames corresponds to one of the plurality of distance data frames, and the corresponding visual data frame and the distance data frame are obtained at a same time;

instructions for performing a loop closure detection based on a current visual data frame in the plurality of visual data frames to find a matched visual data frame;

instructions for calculating a relative pose between the current visual data frame and the matched visual data frame, in response to being found the matched visual data frame; and

instructions for performing a loop closure optimization on pose data of one or more frames between the current visual data frame and the matched visual data frame based on the relative pose.

The distance data frame is obtained through the distance sensor 220, and the visual data frame is obtained through the visual sensor 230. In this embodiment, the distance sensor 220 is a laser sensor, and the visual sensor 230 is a camera. In other embodiments, the distance sensor 220 may be other type of distance sensor, and the visual sensor 230 may be other type of visual sensor.

FIG. 2 is a flow chart of a first embodiment of a visual assisted distance-based SLAM method according to the present disclosure. A visual assisted distance-based SLAM method for a mobile robot is provided. In this embodiment, the method is a computer-implemented method executable for a processor, which may be implemented through a distance-based SLAM apparatus. As shown in FIG. 2, the method includes the following steps.

S1: obtaining distance data frames from a laser sensor and visual data frames from a camera.

In this embodiment, the distance data frame is obtained by using the laser sensor, and the visual data frame is obtained by using the camera. In other embodiments, the distance data frame may be obtained by using other type of distance sensor, and the visual data frame may be obtained by using other type of visual sensor. The distance sensor may be a laser radar, an ultrasonic ranging sensor, an infrared ranging sensor, or the like. The visual sensor may include an RGB camera and/or a depth camera. The RGB camera can obtain image data, and the depth camera can obtain depth data. If the visual sensor only includes RGB cameras, the number of the RGB cameras can be greater than one. For example, two RGB cameras may compose a binocular camera, so that images data of the two RGB cameras can be utilized to calculate the depth data. The image data and/or depth data obtained by the visual sensor may be directly used as a visual data frame, or may extract feature data from the image data and/or the depth data to use as the visual data frame so as to save storage space, where the feature data may include map point data extracted from the image data and/or the depth data. The original image data and/or depth data may be deleted after the feature data is extracted. For example, feature point detection may be performed on the image data, and the 3D map points corresponding to the feature points are generated in conjunction with the depth data, and the descriptors of the feature points are calculated, and the feature data (including the feature points, the 3D map points, and the descriptors) is used as the visual data frame. In one embodiment, the visual data frames may be obtained from a visual data frame history dataset.

Each visual data frame corresponds to one distance data frame, and the visual data frame and the distance data frame which correspond to each other are obtained at a same time, and the carrier is at a same pose (a pose is composed of a position and a posture). The distance data frame and the visual data frame may have a one-to-one correspondence, or may not have. If the distance data frame and the visual data frame do not have the one-to-one correspondence, a part of the distance data frames may have no corresponding visual data frame.

There is an ID (identification) for each distance data frame and each visual data frame. The IDs of the visual data frame and the distance data frame which correspond to each other may be matched for ease of processing, for example, the corresponding visual data frame and distance data frame may have the same ID.

There is no limit to the order in obtaining the visual data frame and the distance data frame in the same frame. For instance, obtaining the corresponding visual data frame by sending a signal to the visual sensor after a lidar scans to obtain the distance data frame, or controlling the visual sensor to obtain the corresponding visual data frame during the scanning process of the lidar, or the lidar starts to scan after controlling the visual sensor to obtain the visual data frame.

S2: performing a loop closure detection based on a current visual data frame in the visual data frames to find a matched visual data frame.

The current visual data frame refers to the visual data frame in processing, and is not necessarily the visual data frame obtained at the current time. In general, the loop closure detection is based on the similarity of images. The matched visual data frame and current visual data frame are collected in the same or similar scene. If the loop closure detection is successful, the number of the matched visual data frames may be one or more.

S3: calculating a relative pose between the current visual data frame and the matched visual data frame, if the matched visual data frame is found.

S4: performing a loop closure optimization on pose data of frames between the current visual data frame and the matched visual data frame based on the relative pose.

If the matched distance data frame corresponding to the earliest matched visual data frame is the ath frame, the current distance data frame corresponding to the current visual data frame is the bth frame, and the object of the loop closure optimization may include the pose data of at least part of the ath to the bth frame. In addition to the pose information, it is also possible to perform loop closure optimization on at least part of the map point data. After the loop closure optimization is completed, the pose data after the loop closure optimization can be stored in the map data.

In the case that the loop closure optimization is completed or no matched visual data frame is found, it can be used another visual data frame as the current data frame and returns to step S2 so as to execute step S2 and subsequent steps.

In this embodiment, the distance SLAM is optimized by using the result of the loop closure detection to the visual data. Since the visual data contains more information than the distance data, the success rate of the loop closure detection of the visual data is higher, the cumulative error can be eliminated, and the reliability of long-term estimation is improved, thereby improving the accuracy of the mapping.

FIG. 3 is a flow chart of a second embodiment of a visual assisted distance-based SLAM method according to the present disclosure. As shown in FIG. 3, the second embodiment of the visual assisted distance-based SLAM method is based on the first embodiment of the visual assisted distance-based SLAM method, and step S2 of the first embodiment of the visual assisted distance-based SLAM method may specifically include the following steps.

S21: finding a candidate visual data frame having a similarity to the current visual data frames larger than a preset threshold to use as the matched visual data frame.

Each candidate visual data frame is before the current visual data frame, and spaces from the current visual data frame in a preset range. The space (i.e., frame spacing) between the serial numbers of two frames. The maximum value of the preset range may be positively correlated with the frame rate of the distance data frame.

S22: checking the current visual data frame and a matched frame to remove the unqualified matched visual data frame.

In general, the loop closure detection may be based mainly on the similarity of appearance features without considering geometric information, and the matched visual data frames obtained by the loop closure detection may include dummy matched visual data frames. The dummy matched visual data frame and the current visual data frame are similar in appearance, but are not obtained in the same scene. If the loop closure optimization is performed based on the dummy matched visual data frame, the accuracy of mapping and/or localization may be affected, hence a calibration may be performed to remove unqualified matched visual data frames, that is, the dummy matched visual data frame. The matched frame may include the matched visual data frame and/or the matched distance data frame corresponding to the matched visual data frame.

In one embodiment, a random sampling consistency filtering may be performed on map point data of the current visual data frame and map point data of the matched visual data frame to remove the unqualified matched visual data frame. For example, for one matched visual data frame, a point pair matching can be performed between the feature points in the map point data of the matched visual data frame and the feature points in the map point data of the current visual data frame. After the point pair matching is completed, some point pairs are randomly adopted to estimate the pose between the two frames, then the remaining point pairs are used to verify the correctness of the pose. The point pair meeting the pose are inner points, otherwise are outlier points, and the number of the inner points is recorded. The above steps are repeated for several times, and the pose with the most inner points is selected as a pose result. If the number of the inner points corresponding to the obtained pose result is less than a threshold, the matched visual data frame is unqualified, otherwise the matched visual data frame is qualified. The above-mentioned process is performed on each matched visual data frame to filter out the qualified matched visual data frames. The unqualified matched visual data frames may be deleted. If all the matched visual data frames found are unqualified, it can be considered that the current visual data frame does not have the matched visual data frame. Optionally, if the number of the qualified matched visual data frames is larger than one, it may reserve only one of the qualified matched visual data frames which has the most number of corresponding inner points for subsequent loop closure optimization.

FIG. 4 is a flow chart of a third embodiment of a visual assisted distance-based SLAM method according to the present disclosure. As shown in FIG. 4, the third embodiment of the visual assisted distance-based SLAM method is based on the first embodiment of the visual assisted distance-based SLAM method and further includes the following steps.

S5: obtaining current visual data from the camera.

The current visual data is obtained by using a visual sensor.

S6: searching for a matching visual data frame among the plurality of visual data frames by performing a loop closure detection on the current visual data.

The format of the current visual data should be consistent with the format of the visual data frames. For example, if the stored visual data frame is the extracted feature data, the current visual data should be the extracted feature data. For a detailed description of the loop closure detection, reference may be made to the related content of the above-mentioned embodiment, which is not repeated herein.

S7: calculating a relative pose between the current visual data and the matching visual data frame, if the matching visual data frame is found.

S8: calculating the current pose based on the relative pose and the pose data corresponding to the matching visual data frame.

This embodiment describes the process of quickly determining the current pose and completing the overall relocalization by using the loop closure detection in the case that the tracking is lost during the booting/localization process of the carrier.

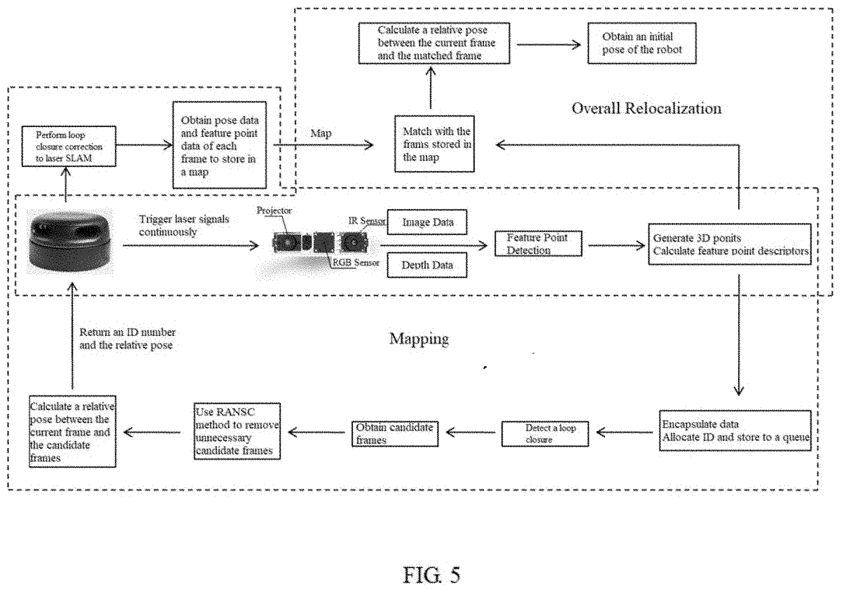

FIG. 5 is a schematic block diagram of an overall scheme of a laser SLAM according to an embodiment of the visual assisted distance-based SLAM method of the present disclosure. As shown in FIG. 5, in this embodiment, the pose data of each frame is obtained by calculating the laser data frame, and the relative pose between the current frame and the matched frame calculated after the loop closure detection is only used to calibrate the calculated pose data, which does not involve the initial calculation of the pose data. That is to say, the visual assistance is decoupled from the laser SLAM and does not require substantial modifications to the laser SLAM algorithm.

FIG. 6 is a flow chart of a fourth embodiment of a visual assisted distance-based SLAM method according to the present disclosure. As shown in FIG. 6, the method includes the following steps.

S10: obtaining current visual data by a camera.

The current visual data is obtained by using a visual sensor. The visual sensor may include an RGB camera and/or a depth camera. The RGB camera can obtain image data, and the depth camera can obtain depth data. If the visual sensor only includes RGB cameras, the number of the RGB cameras can be greater than one. For example, two RGB cameras may compose a binocular camera, so that images data of the two RGB cameras can be utilized to calculate the depth data. The image data and/or depth data obtained by the visual sensor may be directly used as a visual data frame, or may extract feature data from the image data and/or the depth data to use as the current visual data.

S20: searching for a matching visual data frame among the plurality of stored visual data frames by performing a loop closure detection on the current visual data.

The format of the current visual data should be consistent with the format of the visual data frames. For example, if the stored visual data frame is the extracted feature data, the current visual data should be the extracted feature data. For a detailed description of the loop closure detection, reference may be made to the related content of the above-mentioned embodiment, which is not repeated herein.

S30: calculating a relative pose between the current visual data and the matching visual data frame, if the matching visual data frame is found.

S40: calculating the current pose based on the relative pose and the pose data corresponding to the matching visual data frame.

This embodiment describes the process of quickly determining the current pose and completing the overall relocalization by using the loop closure detection in the case that the tracking is lost during the booting/localization process of the carrier.

In this embodiment, the result of the loop closure detection to the visual data is used to assist the localization of the distance SLAM. Since the visual data contains more information than the distance data, the success rate of the loop closure detection of the visual data is higher, and the current pose can be quickly determined to perform the overall relocalization.

The present disclosure further provides a distance-based SLAM apparatus (device) including a processor. The processor can operate alone or in cooperation with other processors.

The processor controls the operation of the visual assisted distance-based SLAM apparatus, which may also be referred to as a CPU (Central Processing Unit). The processor may be an integrated circuit chip which is capable of processing a signal sequence. The processor can also be a general purpose processor, a digital signal sequence processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The processor is configured to execute instructions to implement any of the embodiments of the visual assisted distance-based SLAM method of the present disclosure and the methods provided by the non-conflicting combination.

The present disclosure further provides a computer readable storage medium including a memory 310 for storing instructions. When the instructions are executed, any of the embodiments of the visual assisted distance-based SLAM method of the present disclosure and any non-conflicting combination are implemented.

The memory may include a read-only memory (ROM), a random access memory (RAM), a flash memory, a hard disk, an optical disk, and the like.

In the embodiments provided by the present disclosure, it is to be understood that the disclosed methods and devices can be implemented in other ways. For example, the device embodiments described above are merely illustrative; the division of the modules or units is merely a division of logical functions, and can be divided in other ways such as combining or integrating multiple units or components with another system when being implemented; and some features can be ignored or not executed. In another aspect, the coupling such as direct coupling and communication connection which is shown or discussed can be implemented through some interfaces, and the indirect coupling and the communication connection between devices or units can be electrical, mechanical, or otherwise.

The units described as separated components can or cannot be physically separate, and the components shown as units can or cannot be physical units, that is, can be located in one place or distributed over a plurality of network elements. It is possible to select some or all of the units in accordance with the actual needs to achieve the object of the embodiments.

In addition, each of the functional units in each of the embodiments of the present disclosure can be integrated in one processing unit. Each unit can be physically exists alone, or two or more units can be integrated in one unit. The above-mentioned integrated unit can be implemented either in the form of hardware, or in the form of software functional units.

The integrated unit can be stored in a computer-readable storage medium if it is implemented in the form of a software functional unit and sold or utilized as a separate product. Based on this understanding, the technical solution of the present disclosure, either essentially or in part; contributes to the prior art, or all or a part of the technical solution can be embodied in the form of a software product. The software product is stored in a storage medium, which includes a number of instructions for enabling a computer device (which can be a personal computer, a server, a network device, etc.) or a processor to execute all or a part of the steps of the methods described in each of the embodiments of the present disclosure. The above-mentioned storage medium includes a variety of media such as a USB disk, a mobile hard disk, a read-only memory (ROM), a random access memory (RAM), a magnetic disk, and an optical disk which is capable of storing program codes.

The foregoing is merely embodiments of the present disclosure, and is not intended to limit the scope of the present disclosure. Any equivalent structure or flow transformation made based on the specification and the accompanying drawings of the present disclosure, or any direct or indirect applications of the present disclosure on other related fields, shall all be covered within the protection of the present disclosure.

What is claimed is:

1. A computer-implemented visual assisted distance-based simultaneous localization and mapping method for a mobile robot, comprising executing on a processor the steps of:
obtaining a plurality of distance data frames from a laser sensor and a plurality of visual data frames from a camera, wherein each of the plurality of visual data frames corresponds to one of the plurality of distance data frames, and the corresponding visual data frame and the distance data frame are obtained at a same time;
performing a loop closure detection based on a current visual data frame in the plurality of visual data frames to find a matched visual data frame;
calculating a relative pose between the current visual data frame and the matched visual data frame, in response to being found the matched visual data frame; and
performing a loop closure optimization on pose data of one or more frames between the current visual data frame and the matched visual data frame based on the relative pose.

2. The method of claim 1, wherein the step of performing the loop closure detection based on the current visual data frame in the plurality of visual data frames to find the matched visual data frame comprises:
finding a candidate visual data frame having a similarity to the current visual data frames larger than a preset threshold to use as the matched visual data frame, wherein the candidate visual data frame is before the current visual data frame and spaces from the current visual data frame in a preset range.

3. The method of claim 2, wherein the step of performing the loop closure detection based on the current visual data frame in the plurality of visual data frames to find the matched visual data frame further comprises:
checking the current visual data frame and a matched frame to remove the unqualified matched visual data frame.

4. The method of claim 3, wherein the step of checking the current visual data frame and the matched frame to remove the unqualified matched visual data frame comprises:
performing a random sampling consistency filtering on map point data of the current visual data frame and map point data of the matched visual data frame to remove the unqualified matched visual data frame.

5. The method of claim 2, wherein the maximum value of the preset range is positively correlated with a frame rate of the distance data frames.

6. The method of claim 1, further comprising:
storing the pose data after the loop closure optimization in map data.

7. The method of claim 6, further comprising:
obtaining current visual data from the camera;
searching for a matching visual data frame among the plurality of visual data frames by performing a loop closure detection on the current visual data;
calculating a relative pose between the current visual data and the matching visual data frame, in response to the matching visual data frame being found; and
calculating the current pose based on the relative pose and the pose data corresponding to the matching visual data frame.

8. A computer-implemented visual assisted distance-based simultaneous localization and mapping method for a mobile robot, comprising executing on a processor the steps of:
obtaining current visual data by a camera;
searching for a matching visual data frame among the plurality of stored visual data frames by performing a loop closure detection on the current visual data;
calculating a relative pose between the current visual data and the matching visual data frame, in response to the matching visual data frame being found; and
calculating the current pose based on the relative pose and the pose data corresponding to the matching visual data frame.

11. A mobile robot, comprising:
a processor;
a laser sensor;
a camera; and
one or more computer programs stored in the memory and executable on the processor, wherein the processor is coupled to each of the laser sensor and the camera, and the one or more computer programs comprise:
instructions for obtaining a plurality of distance data frames from the laser sensor and a plurality of visual data frames from the camera, wherein each of the plurality of visual data frames corresponds to one of the plurality of distance data frames, and the corresponding visual data frame and the distance data frame are obtained at a same time;
instructions for performing a loop closure detection based on a current visual data frame in the plurality of visual data frames to find a matched visual data frame;
instructions for calculating a relative pose between the current visual data frame and the matched visual data frame, in response to being found the matched visual data frame; and
instructions for performing a loop closure optimization on pose data of one or more frames between the current visual data frame and the matched visual data frame based on the relative pose.

12. The mobile robot of claim 11, wherein the instructions for performing the loop closure detection based on the current visual data frame in the plurality of visual data frames to find the matched visual data frame comprise:
instructions for finding a candidate visual data frame having a similarity to the current visual data frames larger than a preset threshold to use as the matched visual data frame, wherein the candidate visual data frame is before the current visual data frame and spaces from the current visual data frame in a preset range.

13. The mobile robot of claim 12, wherein the instructions for performing the loop closure detection based on the current visual data frame in the plurality of visual data frames to find the matched visual data frame further comprise:
instructions for checking the current visual data frame and a matched frame to remove the unqualified matched visual data frame.

14. The mobile robot of claim 13, wherein the instructions for checking the current visual data frame and the matched frame to remove the unqualified matched visual data frame comprise:
instructions for performing a random sampling consistency filtering on map point data of the current visual data frame and map point data of the matched visual data frame to remove the unqualified matched visual data frame.

15. The mobile robot of claim 12, wherein the maximum value of the preset range is positively correlated with a frame rate of the distance data frames.

16. The mobile robot of claim 11, wherein the one or more computer programs further comprise:
instructions for storing the pose data after the loop closure optimization in map data.

17. The mobile robot of claim 16, wherein the one or more computer programs further comprise:
instructions for obtaining current visual data from the camera;
instructions for searching for a matching visual data frame among the plurality of visual data frames by performing a loop closure detection on the current visual data;
instructions for calculating a relative pose between the current visual data and the matching visual data frame, in response to the matching visual data frame being found; and
instructions for calculating the current pose based on the relative pose and the pose data corresponding to the matching visual data frame.

18. The mobile root of claim 11, wherein the laser sensor is a laser radar, the camera comprises at least one of an RGB camera and a depth camera.
